(19) United States
(12) Patent Application Publication
(10) Pub. No.: US 2013/0176143 A1
(43) Pub. Date: Jul. 11, 2013

(54) MONITORING METHOD, SYSTEM AND DEVICE

(71) Applicant: Philip Murray Ivanier, Auckland (NZ)

(72) Inventor: Philip Murray Ivanier, Auckland (NZ)

(73) Assignee: TELECOM IP LIMITED, Wellington (NZ)

(21) Appl. No.: 12/530,902

(22) PCT Filed: Mar. 12, 2008
(86) PCT No.: PCT/NZ08/00049

§ 371 Date: Mar. 19, 2010

(30) Foreign Application Priority Data
Mar. 12, 2007 (NZ) 553781

(51) Int. Cl. G08C 17/02

(52) U.S. Cl. CPC G08C 17/02
USPC 340/870.03

(57) ABSTRACT

The invention provides a monitoring method. The method includes collecting data using one or more sensors, transmitting the data wirelessly to one or more residential gateways, each residential gateway being a device installed in a premises to at least provide the premises with access to the internet, and transmitting the data from the one or more residential gateways to a central database via the internet. The invention also provides related systems and devices.

### FIELD OF THE INVENTION

The present invention relates to a monitoring method, system and device. In particular, but not exclusively, the present invention relates to a monitoring method, system and device using residential gateways.

### BACKGROUND TO THE INVENTION

The past few years have seen numerous advances in the monitoring field. The most notable of advances are those in automatic meter reading (AMR), where a system is provided to replace or reduce to some extent the need for a person to physically visit a location to read a utility meter at a premises. Such AMR systems typically include a battery-powered module in the user's premises, which senses the utility meter reading, encodes the reading and transmits it periodically over a wireless network to a central station.

Advances in the monitoring field are not limited to AMR systems. Other developments in monitoring include wireless monitoring of the condition or environment of some remote system. For example, the remote system may be a gas distribution system that uses wireless temperature sensors to monitor the temperature levels in its gas pipes. Alternatively, the remote system may be a patient's home, which includes devices to sense the condition of a patient and to wirelessly send a report to a medical facility.

There are a number of known techniques in the prior art to implement the above monitoring systems. One technique in the prior art resorts to placing a high-sensitive receiver on utility poles to receive the transmission from as many modules as possible. As for monitoring remote sites, cellular networks have been used to transport data from the sensors to a central station. Another prior art technique is described in PCT Publication WO 2004/102503. Specifically, the publication describes a gap coverage method, where identification codes are used by a central station to determine if there are any modules that have not transmitted data. If so, a low-cost receiver is placed adjacent the module to ensure there is no gap in the coverage that may be preventing the module from transmitting its data.

It should be noted that the reference to the PCT publication above (and any other reference to patent specifications, other external documents, or other sources of information in this specification) has been made for the purpose of providing a context for discussing the features of the present invention. Unless specifically stated otherwise, the reference is not to be construed as an admission that the publication (or documents or sources of information) is prior art or that it forms part of the common general knowledge in the art in any jurisdiction.

### OBJECT OF THE INVENTION

The object of the present invention is to either provide a monitoring method, system and device that is cost-effective and that operates in a secure, redundant manner, or at least provide the public with a useful choice.

### SUMMARY OF THE INVENTION

In one aspect, the present invention broadly relates to a monitoring method comprising the steps of:

collecting data using one or more sensors;
transmitting the data wirelessly to one or more residential gateways, each residential gateway being a device installed in a premises to at least provide the premises with access to the internet; and
transmitting the data from the one or more residential gateways to a Central database via the internet.

The term ‘comprising’ as used in this specification means ‘consisting at least in part of’, that is to say when interpreting statements in this specification which include that term, the features, prefaced by that term in each statement, all need to be present but other features can also be present. Related tern's such as ‘comprise’ and ‘comprised’ are to be interpreted in similar manner.

The term ‘data’ as used in this specification in relation to sensors denotes information relating to one or more conditions or parameters that are determinable using sensors and that may be of interest to bodies such as local councils, companies, medical facilities, general consumers and the like. The term therefore covers data relating to the usage of electricity, water or gas (i.e. utilities), or data relating to water levels, wind speed or direction, temperature, noise and the air quality of an environment being monitored (i.e. environment), data relating to the condition of an appliance in the premises, or industry specific data such as soil moisture level or ultraviolet level. These are, of course, non-limiting examples only. Skilled persons will appreciate that the term is intended to broadly cover data relating to any condition or parameter that might be of interest and that should be monitored.

The term ‘residential gateway’ as used in this specification denotes a device that is installed at a premises to allow multiple devices in the premises access to the internet and optionally to other communication services via a high-speed digital subscriber line (DSL) or like internet connection. For example, a residential gateway may allow devices such as telephones and computers in a home network to connect to the internet for voice-over-internet protocol (VoIP) communications.

Preferably, the method further comprises the step of automatically establishing a wireless connection between the one or more sensors and at least one residential gateway with no human interaction that is within range of wireless communication with the one or more sensors. In a particularly preferred form, the automatic wireless connection is established between the one or more sensors and all of the residential gateways that are within range of wireless communication with the one or more sensors.
Preferably, the data are transmitted to at least two residential gateways. Alternatively or additionally, the data are transmitted to as many residential gateways as possible. In one preferred form, the data are transmitted over a WiFi link to the residential gateways.

Preferably, the method further comprises the step of comparing copies of the same data received from at least two residential gateways. In one form, the method further comprises the step of deleting unwanted copies of the same data received from the at least two residential gateways.

Preferably, the method further comprises the step of encrypting the data before transmitting it to the residential gateways.
Preferably, the one or more sensors sense a condition or parameter relating to a utility. In this fond, the data preferably includes information relating to two or more of the following: date, time, current usage, past usage, current load of the utility, sensor ID and residential gateway ID.

Preferably, the one or more sensors sense a condition or parameter relating to an environment. In this form, the data preferably includes information relating to two or more of the following: date, time, temperature level, wind speed, wind direction, water level, sensor ID and residential gateway ID.

Preferably, the one or more sensors sense a condition or parameter relating to a device in or around the same premises as the residential gateways. In this faun, the data preferably includes information relating to two or more of the following: date, time, device status, sensor ID and residential gateway ID.

Preferably, at least two sensors are used, each to collect different data. In one form, the different data relate to different measurements of a utility. In another form, the different data relate to different environmental conditions. In yet another form, the different data relate to different devices or different aspects of the same device being monitored.

Preferably, a predetermined virtual circuit of the residential gateways is configured to transmit the data to the central database.

Preferably, the method further comprises the step of monitoring the data at the central database to determine if there is a change in the residential gateways' reporting pattern.

Preferably, the one or more sensors form part of one or more reporting devices, and the method further comprises the step of transmitting a command from the central database back to the reporting devices. In one form, the reporting devices are operatively coupled to a device being monitored, and the command from the central database is used to control the device being monitored. In another form, the central database is in communication with the device being monitored, and the command from the central database is sent directly to control the device being monitored.

In another aspect, the present invention broadly relates to a monitoring system comprising:
one or more reporting devices, each reporting device having at least one sensor, a processor and a transmitting antenna; and
one or more residential gateways that are installed in a premises to at least provide the premises with access to the internet, wherein the one or more residential gateways are configured to wirelessly receive data from the one or more reporting devices and to forward the data to a central database via the internet.

Preferably, the system is configured such that, when the one or more reporting devices are installed for use, a wireless connection is automatically established between the reporting devices and at least one residential gateway that is within range of wireless communication with the reporting devices. In a particularly preferred form, the automatic wireless connection is established between the reporting devices and all of the residential gateways that are within range of wireless communication with the reporting devices.

Preferably, the reporting devices are configured to transmit the data to at least two residential gateways. Alternatively or additionally, the reporting devices are configured to transmit the data to as many residential gateways as possible. In one preferred form, the reporting devices communicate with the residential gateways over a WiFi link.

Preferably, the central database is configured to compare copies of the same data received from at least two residential gateways.

Preferably, the processor in the reporting device encrypts the data before transmitting it to the residential gateways.

Preferably, the sensors sense a condition or parameter relating to a utility. In this form, the data preferably includes information relating to two or more of the following: date, time, current usage, past usage, current load of the utility, sensor ID and residential gateway ID.

Preferably, the sensors sense a condition or parameter relating to an environment. In this form, the data preferably includes information relating to two or more of the following: date, time, temperature level, wind speed, wind direction, water level, sensor ID and residential gateway ID.

Preferably, the sensors sense a condition or paratheter relating to a device in the same premises as one or more of the residential gateways. In this form, the data preferably includes information relating to two or more of the following: date, time, device status, sensor ID and residential gateway ID.

Preferably, at least two reporting devices are used, each to collect different data. In one form, the different data relate to different measurements of a utility. In another form, the different data relate to different environmental conditions. In yet another form, the different data relate to different devices or different aspects of the same device being monitored.

Preferably, a predetermined virtual circuit of the residential gateways is configured to transmit the data to the central database.

Preferably, the central database is configured to monitor the data from the residential gateways to determine if there is a change in the residential gateways' reporting pattern.

Preferably, the central database sends one or more commands back to the reporting devices. In one form, the reporting device is operatively coupled to the device being monitored, and the command from the central database is used by the reporting device to control the device. In another form, the central database is in communication with the device being monitored, and the command from the central database is sent directly to control the device.

In a further aspect, the present invention broadly relates to a monitoring device comprising:
a residential gateway installed or adapted to be installed in a premises to at least provide the premises with access to the internet;
a receiving antenna to wirelessly receive data from one or more sensors; and
a processor configured to forward the data to a central database via the internet.

In a further aspect, the present invention broadly relates to a reporting device comprising:
one or more sensors to obtain data;
a transmitting antenna;
a processor;
wherein the processor is configured to transmit the data wirelessly using the transmitting antenna to one or more residential gateways, with each residential gateway being configured to at least provide a premises with access to the internet.

The present invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually set forth.

### BRIEF DESCRIPTION OF THE FIGURES

Preferred fowls of the method, system and device of the present invention will now be described with reference to the accompanying figures.

FIG. 1 shows a schematic of the preferred form system of the present invention.

FIG. 2 shows a flow chart showing a preferred form operation of the invention.

FIG. 3 shows one preferred faun residential gateway forming part of the invention.

FIG. 4 shows another preferred form residential gateway forming part of the invention.

### DETAILED DESCRIPTION OF THE PREFERRED FORMS

### The Preferred Form System

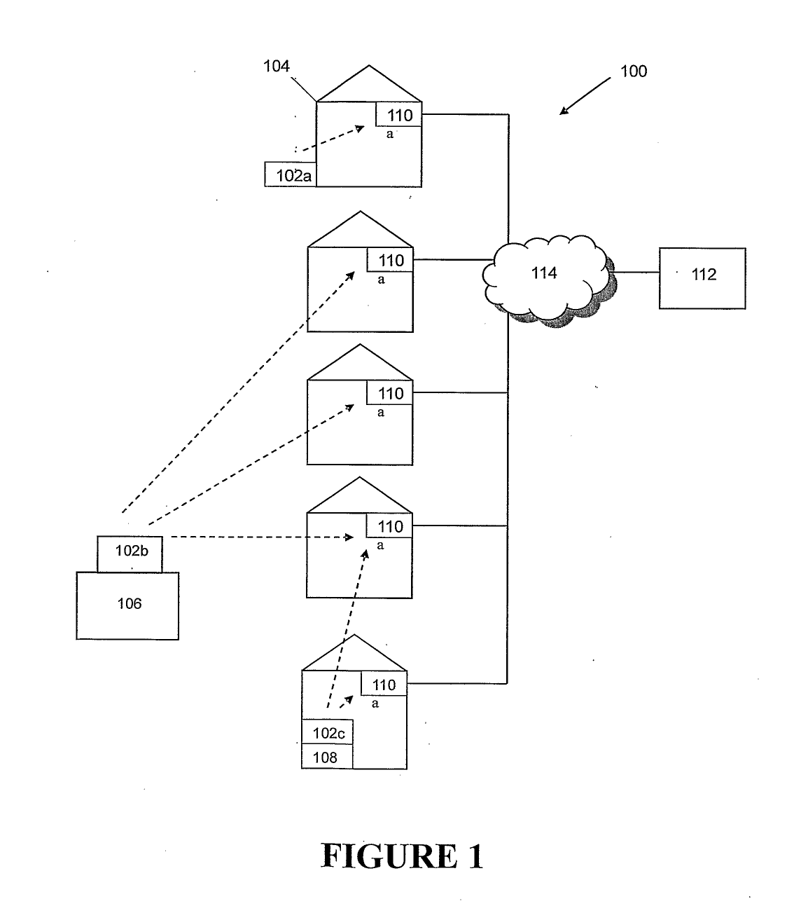

Referring to FIG. 1, the preferred form system is shown generally as 100. The system 100 includes reporting devices 102a to 102c to obtain data. In the form shown, the reporting device 102a is an AMR to obtain data relating to the usage of power in the premises 104, the reporting device 102b is a water meter to obtain data relating to the amount of water in a council's storage tank 106, and the reporting device 102c is a device to obtain appliance-specific data from a home appliance 108.

To obtain the above data, each of the reporting devices 102a to 102c includes at least one sensor. Skilled persons will appreciate that the term ‘sensor’ in the present specification should not be interpreted narrowly; the term is intended to encompass any device capable of detecting or measuring a real-world condition, including acoustic, electromagnetic or optical signals. The sensor may sense a condition or parameter relating to a utility, as is done by the sensor of reporting device 102a. Here, the data sensed may relate to two or more of the following information date, time, current usage, past usage and current load of the utility. Alternatively or additionally, the sensor may sense a condition or parameter relating to an environment, as is done by the sensor of reporting device 102b. In this form, the data may include information relating to two or more of the following: date, time, temperature level, wind speed, wind direction and water level. Further, the sensor may sense a condition or parameter relating to a device in the premises 104, as is done by the sensor of reporting device 102c. In this form, the data may include information relating to two or more of the following: date, time and device status.

It is envisaged that the system 100 may employ at least two sensors, where each sensor is arranged to collect different data. Specifically, the different data may relate to different measurements of a utility, different environmental conditions, different devices or different aspects of the same device being monitored.

The system 100 also includes one or more residential gateways 110. As noted earlier, a residential gateway is a device that is installed in a premises to provide devices in the premises with access to the internet. In other words, the residential gateway provides a link between the network in the premises (the home network) with networks external to the premises. The residential gateways are wireless-enabled and may be configured to operate under digital subscriber line (DSL) technology, other forms of cable technology or optical fibre technology to connect to the network that is external to the premises.

In addition to being configured for the above purpose, the residential gateways 110 are also configured to wirelessly receive data from the reporting devices 102a to 102c. The data received may include the data noted earlier (e.g. time, date, current usage, device status, temperature) and may further include data identifying the sensors, such as sensor ID. In the preferred form, the reporting devices 102a to 102c and the residential gateways 110 are configured to use a wireless networking protocol based on WiFi. Of course, skilled persons will appreciate that other wireless communication systems may be used, including standards-based systems such as Zigbee and non-standards-based systems that operate in accordance with local regulations. Each of the reporting devices 102a to 102c may either communicate with one residential gateway or with multiple residential gateways. For security purposes, the reporting devices 102a to 102c preferably encrypt the data before transmitting it to the residential gateways 110.

In the preferred form, the system 100 is configured such that, when one or more reporting devices 102a to 102c are installed for use, a wireless connection is automatically established between the reporting devices 102a to 102c and at least one residential gateway 110 that is within range of wireless communication with the reporting devices 102a to 102c. In a particularly preferred form, the automatic wireless connection is established with all of the residential gateways 110 that are within range of wireless communication with the reporting devices 102a to 102c.

The residential gateways 110 are also configured to forward the data to a central database 112 via the internet 114. Preferably, the data is sent with information relating to the residential gateway, such as a residential gateway ID. To forward the data to the central database 112, a virtual circuit is configured on the residential gateway to carry the data to the central database 112. As will be known by skilled persons, a virtual circuit is a communications arrangement where data from a source is passed to a destination over two or more real communications circuits during a single period of communication, but where switching between the real circuits is hidden from the user. This configuration is most preferable where a user's internet connection via the residential gateway is based on a usage plan or monthly plan.

Given the system arrangement above, the central database 112 is able to obtain data from the reporting devices 102a to 102c using existing installations of residential gateways. Where each reporting device sends its data to multiple residential gateways (i.e. the reporting device has a one-to-many relationship with the residential gateways), the central database 112 is arranged to verify and collate duplicate copies of the data.

### The Preferred Form Method

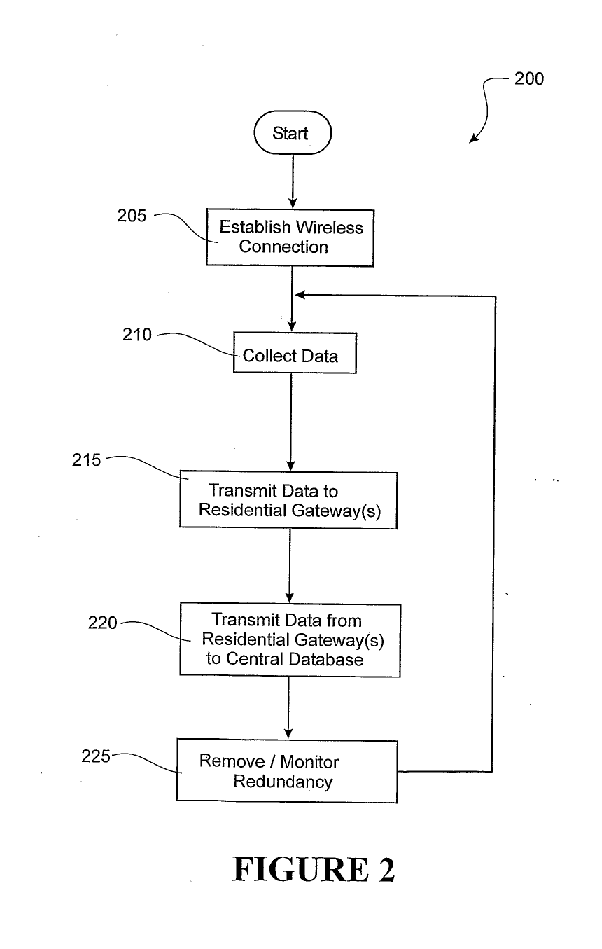

FIG. 2 shows a preferred form method 200. The preferred form method comprises the main steps of collecting data using one or more sensors, transmitting the data wirelessly to one or more residential gateways, and transmitting the data from the one or more residential gateways to a central database via the internet. The method optionally includes establishing a wireless connection and transmitting commands from the central database. It is intended that the order of some of these steps are interchangeable.

The preferred form method optionally includes the step of automatically establishing 205 a wireless connection between the one or more sensors and at least one residential gateway that is within range of wireless communication with the sensors. In a particularly preferred form, the automatic wireless connection is established between the sensors and all of the residential gateways that are within range of wireless communication with the sensors.

The step of collecting data 210 can be carried out continuously or on a fixed schedule. The sensors used for collecting data preferably form part of a reporting device, which would suitably package and transmit the data to the residential gateways. In the preferred form, the method comprises the further step of encrypting the data before transmitting the data to the residential gateways.

The step of transmitting 215 the data to one or more residential gateways preferably comprises transmitting the data to at least two residential gateways, or to as many residential gateways as possible. The step also preferably comprises transmitting the data over a WiFi link to the residential gateways.

The step of transmitting 220 the data from the one or more residential gateways to a central database is preferably carried out using a virtual circuit on the residential gateway, which is provided specifically for transmitting the data to the central database. Once the data reaches the central database, the method preferably further comprises the step of comparing copies of duplicate data received from at least two residential gateways. The method may further include one or more of the following: (i) a step of filtering or deleting unwanted copies of the duplicate data, and (ii) a step of monitoring the data to determine if there is a change in the reporting pattern from the residential gateway.

In one preferred faun the sensor(s) remove(s) or monitor(s) 225 redundancy. Where a sensor continues to transmit the same data to the residential gateway(s), then the central database picks up this fact. Multiple identical readings from the sensor are identified as redundant and removed. In one form the central database checks for a change in reading from a sensor. If there is a change in reporting pattern from the residential gateway(s), then this change is separately reported.

Steps 210, 215, 220 and 225 are repeated continually until an event such as failure of the sensor(s).

### The Preferred Form Device

As noted above, one or more residential gateways are used to forward data received from reporting devices to a central database. In one aspect, the preferred form device of the present invention is a monitoring device that replaces one or more conventional residential gateways. To do this without adversely affecting internet access to a premises, the monitoring device includes a functionally-equivalent residential gateway. The monitoring device also includes a receiving antenna to wirelessly receive data from one or more reporting devices, and a processor configured to forward the data to a central database via the internet. The monitoring device is also configured to automatically establish a wireless connection with the one or more reporting devices when the reporting devices are installed for use. Although the monitoring device is preferably provided as an integrated device, skilled persons will appreciate that some of its components may be provided as a separate module that could be connected to an existing, conventional residential gateway.

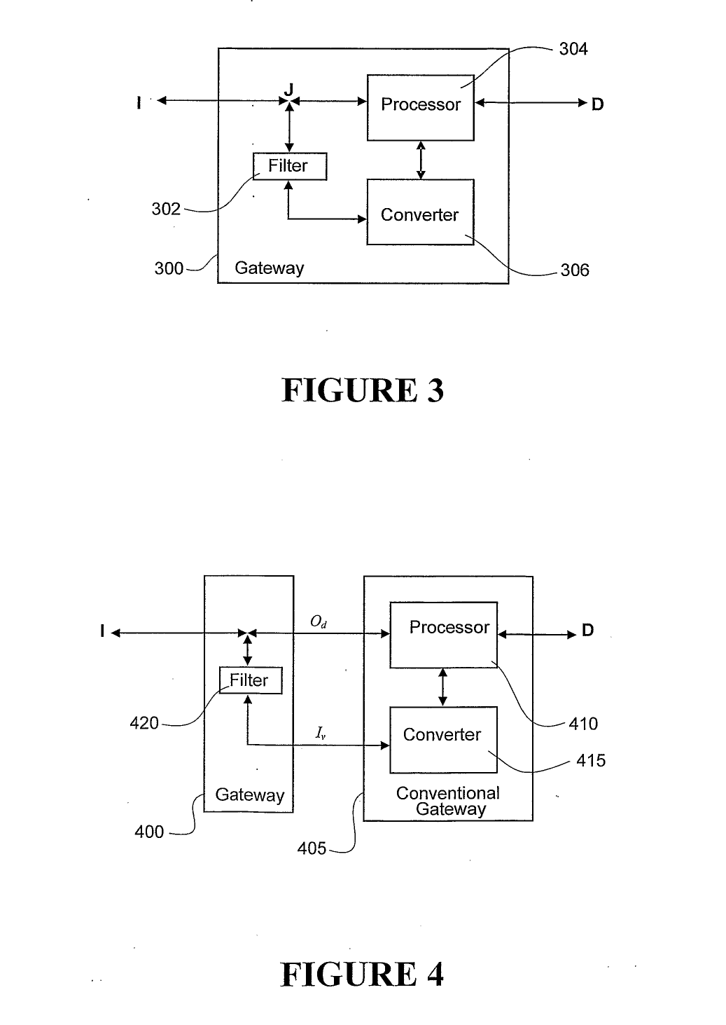

Preferred form residential gateways are described in more detail in our PCT patent application PCT/NZ2007/0001.51. FIG. 3 shows a residential gateway 300 for providing a next-generation communication system, VoIP for instance, to a user. It is intended that the gateway 300 be inserted into any one of the telephony appliance jacks in a consumer's premises. Delivery of ADSL and telephone services is achieved using the fact that analogue telephony data and broadband data occupy different spectrums (0-3 kHz for analogue telephony and 30 kHz-3 MHz for broadband). The voice telephone system is matched to 600 ohms, while ADSL technology is designed for 100 ohms.

The gateway 300 includes an input I to receive broadband signals carrying next-generation communication data from a network. In the preferred form, the input receives xDSL signals carrying, amongst others, VoIP data via a standard BT Jack, RJ-11, RJ-12, RJ-14 or RJ-45 plug that is plugged into a corresponding telephone jack at a user's premises.

The xDSL signals received at input I are preferably first sent to a processor 304. The main function of the processor 304 is to extract the VoIP data from incoming xDSL signals, and to later incorporate VoIP data into outgoing xDSL signals. In the preferred form, the processor 304 is a conventional modem device that demodulates the incoming xDSL signals, and modulates the outgoing xDSL signals. The demodulation using the modem device produces data signals at port D that may be used by a computer or like device, similar to conventional DSL modems. The demodulation also produces VoIP data that are sent to a converting means 306.

A converting means or converter 306, in the preferred form, is a conventional Analogue Telephone Adapter (ATA). The function of the converting means is to suitably convert digital signals, which represent VoIP data coming in from the processor 304, to analogue telephone signals to be received by conventional telephones, and vice versa.

In the preferred form of the present invention, the analogue telephone signals produced by the converting means 306 are sent to a filtering means or filter 302. The filtering means 302 is designed to substantially shield the converting means 306 from incoming xDSL signals, where intermodulation of signals may be a problem in the user's premises. Normally, signals of different frequencies can be present on the same wiring without interfering with each other. However, if there are non-linear devices connected to the wiring, the signals of different frequencies may intermodulate with each other, and with themselves. This can result in audible noises over conventional telephones in the premises. Non-linear, in the above context, means that the output signals of the device are not directly proportional to the input signals. As some converting means 306 may have non-linear properties, the placement of a filtering means 302 adjacent the converting means 306 may prevent intermodulation from occurring. If the processor 304 is also likely to have non-linear properties, the filtering means 302 may be adapted and moved to the joining point, J.

In the simplest form of the present invention, a filtering means is not required. In a preferred form, as described above, the present invention includes a filtering means to prevent intermodulation and to aid in splitting and combining signals in the apparatus. In the preferred form, the filtering means filters out high frequency components and only allows low frequency components to enter the converting means. The filtering means may also divert high frequency components to the processor. The filtering means may be a passive (unpowered) device made from a network of capacitors, resistors and inductors. Alternatively, the filtering means may be an active device (incorporating amplifiers), or even a digital device. It should be noted that, if the converting means has been designed to be immune to intermodulation, the filtering means will not be required and will be replaced with a combination-and-splitting point for the signals.

FIG. 4 shows another form of gateway apparatus 400 that is shown connected to a conventional gateway 405. As will be known to skilled persons, there are a variety of conventional gateways for VoIP services that come complete with a processor 410, such as a modem, and a converting means 415, such as an ATA. One example gateway is the HomePortal gateway supplied by 2wire (www.2wire.com). To implement the functions of the gateway 300 of FIG. 3, the gateway apparatus 400 need only be provided with suitable inputs, outputs and an optional filtering means 420, and be connected to a conventional gateway 405 as shown in the figure.

As with the gateway 300, the gateway apparatus 400 includes an input Ito receive broadband signals, preferably xDSL signals, carrying VoIP data. The xDSL signals are passed to a data input, such as a Wide Area Network (WAN) socket, of a conventional gateway 405. The gateway 405 then processes the xDSL signals in the manner described with reference to FIG. 3 earlier and outputs analogue telephone signals to a second input, Iᵥ, of the gateway apparatus 400. The filtering means 420 then passes the analogue telephone signals to the input I.

In another aspect, the preferred form device is a reporting device. The reporting device comprises one or more sensors to obtain data, a transmitting antenna and a processor that is configured to send the data wirelessly using the transmitting antenna to one or more residential gateways. The reporting device is also configured, upon installation, to automatically establish a wireless connection with the one or more residential gateways.

The foregoing describes the invention including preferred forms thereof. Alterations and modifications as will be obvious to those skilled in the art are intended to be incorporated within the scope hereof, as defined by the accompanying claims.

1. A monitoring method comprising:
collecting data using one or more sensors;
transmitting the data wirelessly to two or more residential gateways, each residential gateway being a device installed in a premises to at least provide the premises with access to the internet; and
transmitting the data from the two or more residential gateways to a central database via the internet.

2. The method of claim 1 further comprising automatically establishing a wireless connection between the one or more sensors and at least two residential gateways that are within range of wireless communication with the one or more sensors.

3. The method of claim 2 wherein the automatic wireless connection is established between the one or more sensors and all of the residential gateways that are within range of wireless communication with the one or more sensors.

4. The method of claim 1 wherein the data are transmitted to all available residential gateways.

5. The method of any one of claim 1 wherein the data are transmitted over a WiFi link to the residential gateways.

6. The method of claim 1 further comprising comparing copies of the same data received from at least two residential gateways.

7. The method of claim 6 further comprising deleting unwanted copies of the same data received from the at least two residential gateways.

8. The method of claim 1 further comprising encrypting the data before transmitting it to the residential gateways.

9. The method of claim 1 wherein the one or more sensors are configured to sense a condition or parameter relating to a utility.

10. The method of claim 9 wherein the data includes information relating to two or more of the following: date, time, current usage, past usage, current load of the utility, sensor ID and residential gateway ID.

11. The method of claim 1 wherein the one or more sensors are configured to sense a condition or parameter relating to an environment.

12. The method of claim 11 wherein the data preferably includes information relating to two or more of the following: date, time, temperature level, wind speed, wind direction, water level, sensor ID and residential gateway ID.

13. The method of claim 1 wherein the one or more sensors are configured to sense a condition or parameter relating to a device in or around the same premises as the residential gateways.

14. The method of claim 13 wherein the data preferably includes information relating to two or more of the following: date, time, device status, sensor ID and residential gateway ID.

15. The method of claim 9 comprising collecting data using two sensors.

16. The method of claim 15 wherein the two sensors are configured to sense different conditions or parameters relating to a utility.

17. The method of claim 15 wherein the two sensors are configured to sense different conditions or parameters relating to an environment.

18. The method of claim 15 wherein the two sensors are configured to sense different conditions or parameters relating to a device in or around the same premises as the residential gateway(s).

19. The method of claim 1 wherein a predetermined virtual circuit of the residential gateways is configured to transmit the data to the central database.

20. The method of claim 1 further comprising monitoring the data at the central database to determine if there is a change in the reporting pattern of the residential gateway(s).

21. A monitoring system comprising:
one or more reporting devices, each reporting device having at least one sensor, a processor and a transmitting antenna; and
two or more residential gateways that are installed in a premises to at least provide the premises with access to the internet, wherein the two or more residential gateways are configured to wirelessly receive data from the one or more reporting devices and to forward the data to a central database via the internet.

22. The system of claim 21 configured such that, when the one or more reporting devices are installed for use, a wireless connection is automatically established between the reporting devices and at least two residential gateways that are within range of wireless communication with the one or more reporting devices.

23. The system of claim 22 wherein the automatic wireless connection is established between the one or more reporting devices and all of the residential gateways that are within range of wireless communication with the one or more reporting devices.

24. The system of claim 21 wherein the reporting devices are configured to transmit the data to all available residential gateways.

25. The system of claim 21 wherein the reporting devices communicate with the residential gateways over a WiFi link.

26. The system of claim 21 wherein the central database is configured to compare copies of the same data received from at least two residential gateways.

27. The system of claim 21 wherein the processor in the reporting device encrypts the data before transmitting it to the residential gateways.

28. The system of claim 21 wherein the reporting devices sense a condition or parameter relating to a utility.

29. The system of claim 28 wherein the data includes information relating to two or more of the following: date, time, current usage, past usage, current load of the utility, sensor ID and residential gateway ID.

30. The system of claim 21 wherein the reporting devices sense a condition or parameter relating to an environment.

31. The system of claim 30 wherein the data includes information relating to two or more of the following: date, time, temperature level, wind speed, wind direction, water level, sensor ID and residential gateway ID.

32. The system of claim 21 wherein the reporting devices sense a condition or parameter relating to a device in or around the same premises as one or more of the residential gateways.

33. The system of claim 32 wherein the data includes information relating to two or more of the following: date, time, device status, sensor ID and residential gateway ID.

34. The system of claim 28 wherein two reporting devices are used, each to collect different data.

35. The system of claim 34 wherein the two reporting devices are configured to sense different conditions or parameters relating to a utility.

36. The system of claim 34 wherein the two reporting devices are configured to sense different conditions or parameters relating to an environment.

37. The system of claim 34 wherein the two reporting devices are configured to sense conditions or parameters relate to a device in or around the same premises as one or more of the residential gateways.

38. The system of claim 21 wherein a predetermined virtual circuit of the residential gateways is configured to transmit the data to the central database.

39. The system of claim 21 wherein the central database is configured to monitor the data from the residential gateways to determine if there is a change in the reporting pattern of the residential gateways.

40. A monitoring device comprising:
two or more residential gateways installed or adapted to be installed in a premises to at least provide the premises with access to the internet;
a receiving antenna to wirelessly receive data from one or more sensors; and
a processor configured to forward the data to a central database via the internet.

41. A reporting device comprising:
one or more sensors to obtain data;
a transmitting antenna;
a processor;
wherein the processor is configured to transmit the data wirelessly using the transmitting antenna to two or more residential gateways, with each residential gateway being configured to at least provide a premises with access to the internet.
